(19) United States
(12) Patent Application Publication
(10) Pub. No.: US 2008/0313950 A1
(43) Pub. Date: Dec. 25, 2008

(54) Apparatus for Extracting a Fishing Hook

(76) Inventor: Antonio Larcher, Munich (DE)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 12/092,335

(22) PCT Filed: Oct. 25, 2006
(86) PCT No.: PCT/DE06/01886

§ 371 Date: May 1, 2008

(30) Foreign Application Priority Data
Nov. 2, 2005 (DE) 10 2005 052 622.5

(51) Int. Cl. A01K 97/18

(52) U.S. Cl. 43/53.5

(57) ABSTRACT

A device for extracting a fishing hook fastened to a fishing line from the mouth of a fish, having an elongate holding arm and a tubular hook holder which is connected to the front end of the holding arm and can be pivoted by a pivoting device from an engagement position which is oriented forwards into a release position which is oriented backwards, wherein the free internal cross section and the length of the hook holder are dimensioned in such a way that the limb of the fishing hook fits into it, and wherein the hook holder has a lengthwise a slot for introducing the fishing line, and wherein the pivoting device has a connecting rod which acts on the hook holder and is displacable longitudinally along the holding arm. The holding arm is hollow and the connecting rod is arranged in the interior of the holding arm.

### BACKGROUND OF THE INVENTION

1. Field of the Invention

The invention relates to a device for extracting a fish hook from the mouth of a fish comprising an extended retaining arm and a tubular hook holder connected to a front end of the retaining arm, wherein the hook holder may be pivoted from a forward facing engaged position for the fish hook into a rearward facing release position by means of a pivot device, wherein a free inner cross-section and a length of the hook holder are such that a fish hook shaft fits in, wherein the hook holder is embodied over the entire length thereof with a slot for introduction of the fishing line, wherein the pivot device comprises a connecting rod which acts on the hook holder and which is movable along the retaining arm in a longitudinal direction.

2. Description of Related Art

Usually, for extracting a fish hook from the mouth of a fish tongs are used having clamping jaws as long as possible, wherein a jaw spreader may be used for keeping the mouth of the fish open so that the hook can be seen for extraction. Both seizure of the hook by the tong and the manual pulling-out of the hook from the mouth of the fish is difficult, what may result both in injury of the fish (which is a problem if “catch and release” is intended) and in damages of the hook. Moreover, during extraction the tong has to be kept in one hand, while the fish has to be held by the other hand.

From UK Patent Specification 1 366 861, a pistol-shaped tool for removing a fish hook from the mouth of a fish is known, wherein at the front end of the pistol barrel a jaw arrangement is provided which can be closed by operation of a trigger biased towards the open position in order to seize the hook. The jaw arrangement comprises a fixed jaw at the front end of the pistol barrel and a movable jaw which can be pivoted relative to the fixed jaw by a trigger.

From U.S. Pat. No. 6,240,673, a device is known which comprises a handle designed as a trigger, which is connected to one end of each of two rods in a pivotable manner, with the other end of each of the two rods being connected to a tubular hook holder in a pivotable manner which is provided with a slot for introducing the fishing line extending for the entire length of the hook holder. For preparing the extraction first the fishing line is introduced into the hook holder and the entire device, with the rods being arranged parallel to each other, is moved so far into the mouth of the fish until the shaft of the fish hook comes to rest within the hook holder. Then the handle is operated to perform a pivoting movement, whereby the hook holder is caused by the two rods to a pivot in such a manner that the hook is automatically turned out of the mouth of the fish. This device involves the drawback that on the one hand it is relatively susceptible to being damaged and on the other hand it does not enable simple operation; in particular, it does not enable one-hand operation.

From JP 09-000134 a device is known, wherein a retaining arm is provided at its rear end with a handle similar to the handle of a screwdriver and wherein the pivot device is formed by a connecting rod acting on the hook holder, which connecting rod is operable by a trigger which is movable along the retaining arm and which is biased by a spring in order to pivot the hook holder between the engagement position and the release position. The device involves the drawback that on the one hand handling of the device is not very simple and, in particular, one-hand operation is excluded, and on the other hand the connecting rod may be damaged relatively easily.

### SUMMARY OF THE INVENTION

It is an object of the invention to provide for a device for extracting fish hook from the mouth of a fish, wherein the fish hook can be seized and released in an automatic and reliable manner and wherein the danger of the hook hooking in again during removal from the mouth of the fish is eliminated, with the device being particularly robust and reliable.

According to the invention, this object is achieved by a device of the initially mentioned type wherein the retaining arm is hollow and the connecting rod is located in an interior of the retaining arm.

The invention, on the one hand, allows for a safe, sparing, simple and fast release of the fish hook, since the hook holder first will be guided along the stretched fishing line directly to the fish hook and thereafter the fish hook is automatically pivoted in the right direction by actuating the pivoting device. Since the bend of the hook then is oriented towards the throat exit, re-hooking in cannot occur when the hook is pulled out of the throat. On the other hand, since the connecting rod for actuating the hook holder is located in the interior of the hollow retaining arm, the connecting rod is well-protected, thereby providing for a robust and reliable device.

The hook holder may be exchangeable. In this case only a uniform basic device is needed, which may be produced in large numbers and hence in a cost-effective manner, while hook holders of different size may be used with the basic device, whereby the fact that usually for each species of fish special fish hooks and hook sizes are used is taken into account.

Preferably, a handle is arranged at the rear end of the retaining arm in such a manner that the handle and the retaining arm are arranged in a pistol-like manner relative to each other. This pistol-like design of the handle allows for one-hand operation of the device, whereby, for example, the fishing line may be held by the other hand.

A clamping device for the fishing line may be provided in the area of the rear end of the retaining arm. Thereby the fishing line may be fixed relative to the extracting device before the pivoting device is operated, whereafter the fishing line need no longer be held by the other hand for extracting the fish hook.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a side view of an embodiment of a fish hook extraction device according to the invention, with the hook holder being shown in the engaged position;

FIG. 2 is a view like FIG. 1, with the hook holder being shown in the release position;

FIG. 3 is an elevated view of the connecting rod of the device of FIG. 1;

FIG. 4 is a view from below of the retaining arm of the device f FIG. 1;

FIGS. 5a & 5b are an elevated view and a rear view, respectively, of the spring band of the device of FIG. 1;

FIGS. 6a to 6c are views of the head portion of the device of claim 1 seen from the side, from above and from below, respectively;

FIGS. 7a & 7b are a side view and a front view, respectively, of the hook holder of FIG. 1;

FIGS. 8a & 8b are a side view and a front view, respectively, of the handle of the device of FIG. 1;

FIG. 9 is a side view of the slider member of the device of FIG. 1; and

FIG. 10 is an exploded view of the clamping device of the device of FIG. 1.

### DETAILED DESCRIPTION OF THE INVENTION

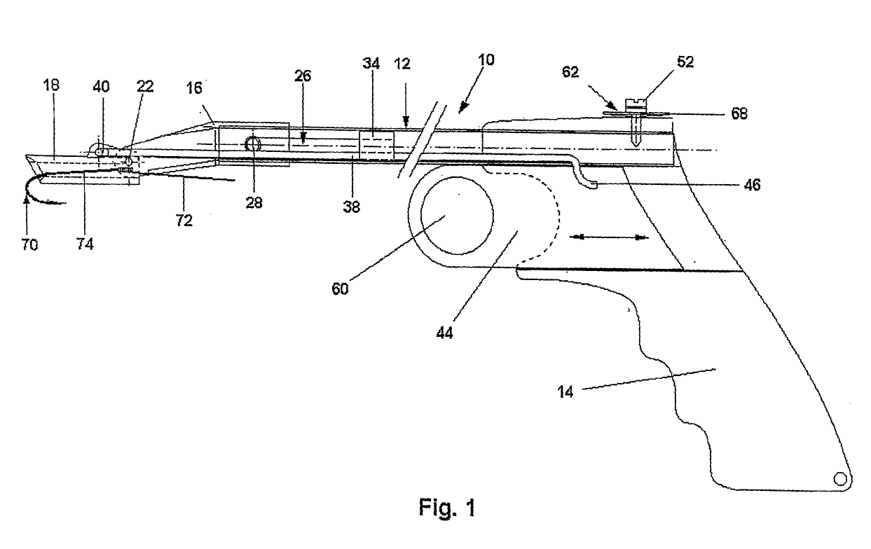

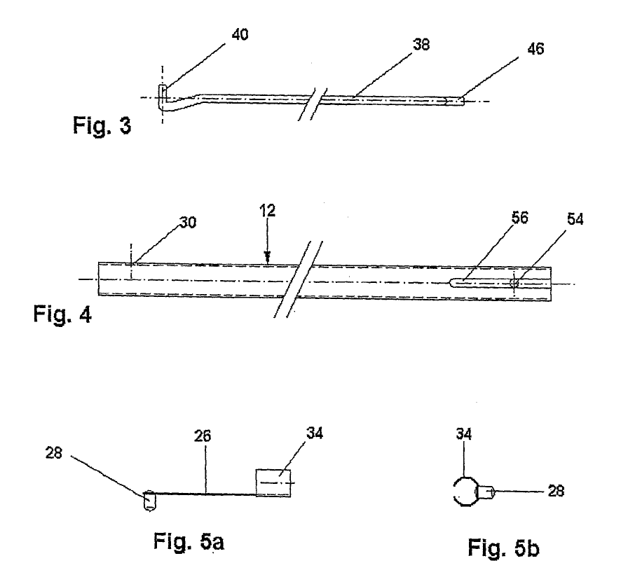

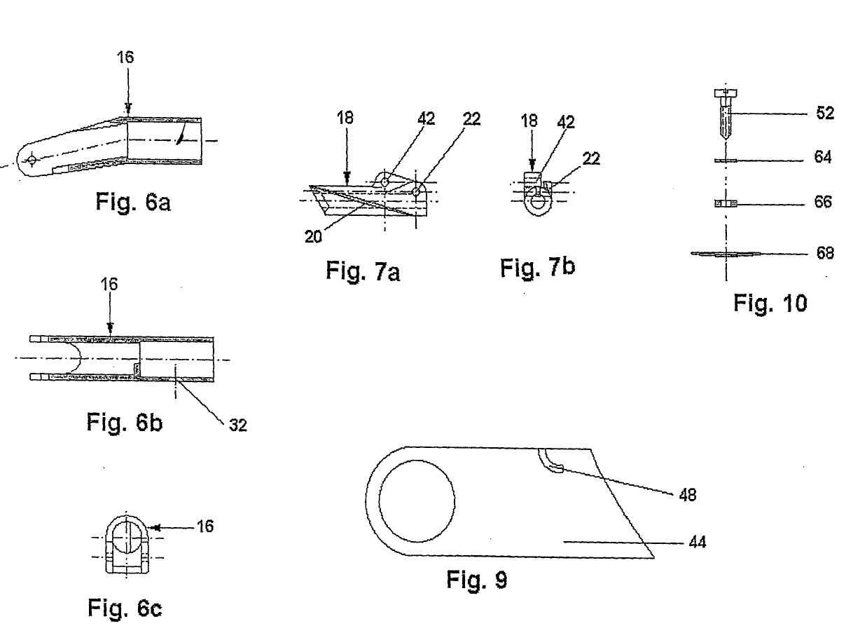

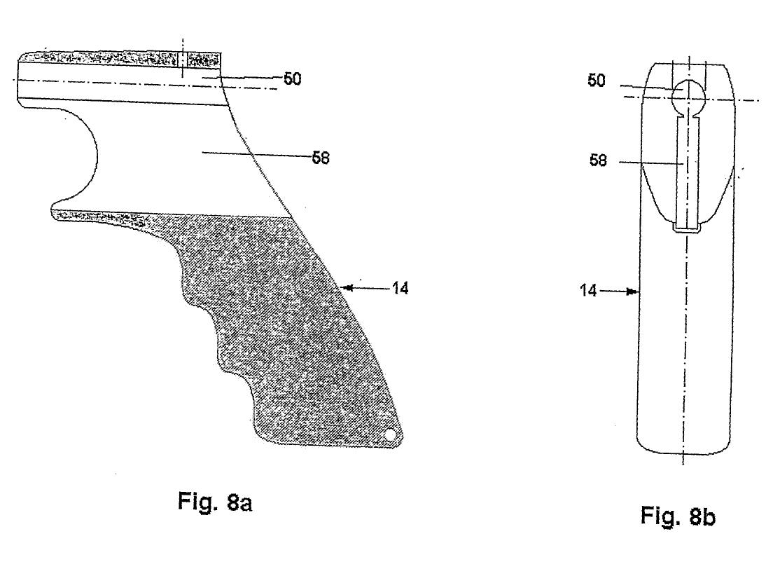

FIGS. 1 & 2 show an embodiment of a fish hook extractor 10 in its entirety in two different functional positions, with some components being separately shown in FIGS. 3 to 10, partly in different views.

The fish hook extractor 10 comprises an extended hollow tubular retaining arm 12 having a rear end which is connected to a handle 14 in such a manner that the retaining arm and the handle 14 form a pistol-like configuration, whereas a head portion 16 is inserted at the front end of the retaining arm 12, with the head portion 16 having a front end which is connected to the hook holder 18 in a pivotable manner.

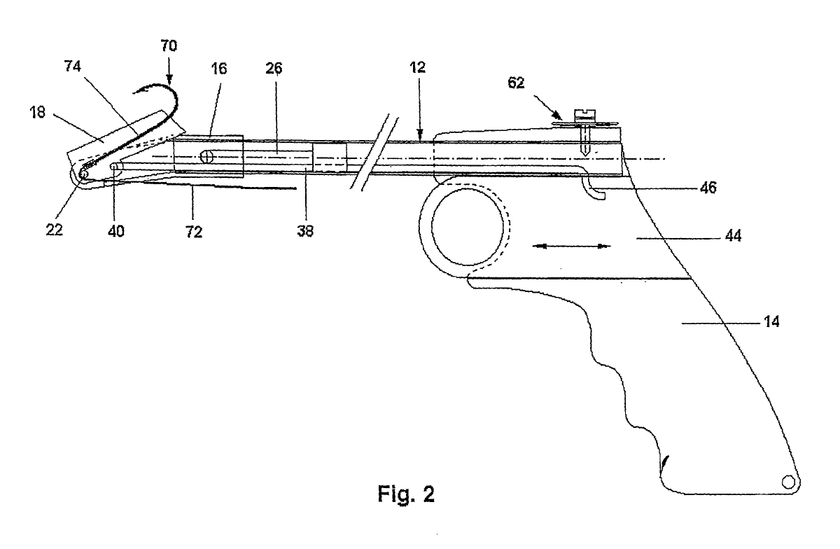

The hook holder 18 has a tubular shape and is provided along its entire length with a spiral slot 20 which is for introducing a fishing line 72 (in FIGS. 1 and 2 only the end of the fishing line 72, which is fixed at the fishhook 70, is shown). The hook holder 18 comprises a rear end which is connected to the head portion 16 via a hinge bolt 22 in a pivotable manner. The head portion 16 is angled in such a manner that the hook holder 18, and in particular the pivot axis 22 thereof, is set-off radially downwardly with regard to the center of the retaining arm 12.

The front end of the hook holder 18 is designed in a funnel-shaped manner (for example, by countersinking) in order to promote the introduction of the fish hook shaft 74. Further, the funnel-shaped front end of the hook holder 18 is made oblique in such a manner (in FIG. 1 downwardly) that the fish hook shaft 74 comes to rest in such a manner (in FIG. 1 the tip points downwardly) that the tip of the fish hook 70 is pulled out of the tissue in the mouth of the fish into which it has hooked-in, when the pivoting movement of the hook holder 18 commences, starting from the engagement position shown in FIG. 1. According to FIG. 1 this is achieved by the fact that the shorter end of the oblique funnel-shaped front end of the hook holder 18 is arranged at that side of the hook holder 18 (in the FIG. 1 at the lower side) which is arranged, when the pivoting movement of the hook holder 18, starting from the engagement position shown in FIG. 1, commences, opposite to that side towards which the hook holder 18 is pivoted (according to FIG. 1 the hook holder 18 is pivoted towards the upper side).

It is appropriate that the slot 20 for introducing the fishing line 72 starts at the longer end (in FIG. 1 at the top) of the oblique funnel-shaped front end of the hook holder 18, so that it is avoided as far as possible that the fishing line 72 un-threads again (according to FIG. 1 the fish hook shaft 72 with the fishing line 72 comes to rest at the shorter end of the oblique funnel-shaped front end of the hook holder 18 (i.e. at the bottom)).

A spring band 26 is arranged in the interior of the retaining arm 12, which comprises a projection 28 at its front end which snaps, via an opening 30 in the wall of the retaining arm 12, into an opening 32 in the wall of the head portion when the head portion 16 is inserted at the front end of the retaining arm 12. The other end of the spring band 26 is formed as a sleeve 34 having an outer side which abuts onto the inner side of the wall of the holding arm 12, with the sleeve 34 being kept in place by a corresponding biasing force acting radially outwardly. In order to facilitate the introduction of the sleeve 34 into the retaining arm 12 the sleeve 34 comprises a lateral slot 36. By actuating the projection 28 of the spring band 26 the head portion 16, together with the hook holder 18, can be exchanged easily.

Moreover, a connecting rod 38 is provided in the interior of the retaining arm 12, having a front end 40, which is angled and which acts on the hook holder 18 by engaging with an opening 42 at the hook holder 18 which is provided at the upper side of the hook holder 18. The connecting rod 38 is longitudinally movable in the interior of the retaining arm 12 by operation of a slider member designed as a trigger, with the two pivotal points 22 and 42 of the hook holder 18 being arranged in such a manner that movement of the connecting rod 38 in the longitudinal direction causes pivoting of the hook holder 18 around the hinge bolt 22. The connecting rod 38 has an angled rear end 46, which engages with a corresponding receptacle 48 in the slider member 44.

The handle 14 is provided with a bore 50 into which the rear end of the retaining arm 12 is inserted, with the rear end of the retaining arm 12 being held by a screw 52 which engages with an opening 54 of the retaining arm 12. The lower side of the retaining arm 12 is provided with a slot 56 through which the angled rear end 46 of the connecting rod 38 engages with the receptacle 48 of the slider member 44.

The slider member 44 is guided in a recess 58 of the handle 14 in such a manner that it is movable in the longitudinal direction, with the front end of the slider member 44 comprising a finger hole 60.

The screw 52 not only serves to fix the retaining arm 12 relative to the handle 14, but it also forms part of a clamping device 62 for the fishing line, which comprises a first plane metal disc 64, a rubber disc 66 and a second convex metal disc 68. The fishing line is clamped between the lower side of the metal disc 68 and the upper side of the handle 14.

Due to the construction described above, the fishhook extractor 10 can be disassembled easily and quickly, for example for being cleaned, wherein the head portion 16 can be detached from the retaining arm 12, the connecting rod 38 can be detached from the hook holder 18 and the slider member 44, the retaining arm 12 can be detached from the handle 14 by releasing the screw 52, and the slider member 44 can be detached from the handle 14 after the connecting rod 38 has been detached.

Preferably, the device is made of such materials that it floats in water.

The fishhook extractor 10 operates as follows:

Starting from the engaged position shown in FIG. 1, in which the hook holder is oriented essentially parallel to the retaining arm 10 by moving the slider member 44 forwardly to the front stop, the fishing line 72 is introduced into the interior of the hook holder 18 via the slot 20, with the fishing line 72 being prevented from leaving the hook holder 18 again by the spiral slot 20.

Then the fish hook extractor 10 is advanced carefully along the fishing line towards the fish hook until the fish hook leg 74 is received by the hook holder 18, with the fishing line 72 acting as a guide. Thereafter the stretched fishing line 72 is clamped in the clamping device 62 by a half-turn. From now on the fishhook extractor 10 can be operated by using only one hand, what is particularly beneficial if the fish wriggles heavily or if the boat is rolling heavily.

If now the finger trigger 60 of the slider member 44 is pulled rearwardly, the front end of the hook holder 18, due to the movement of the connecting rod 38, pivots upwardly around the pivotal point 22 into the release position shown in FIG. 2, which corresponds to a rotation by about 150 degrees. Due to this rotation the hook 70 is automatically released from the mouth of the fish. Since in this position the bend of the hook 70 points outwardly, the hook 70 can be pulled out of the mouth of the fish, together with the fish hook extractor 10, without problems, with the hook 70 being prevented from hooking in again in the mouth of the fish.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. A device for the extraction of a fish hook fixed to a fishing line from a mouth of a fish, comprising an extended retaining arm and a tubular hook holder connected to a front end of the retaining arm, wherein the hook holder may be pivoted from a forward facing engaged position for the fish hook into a rearward facing release position by means of a pivot device, wherein a free inner cross-section and a length of the hook holder are such that a fish hook shaft fits in, wherein the hook holder is embodied over the entire length thereof with a slot for introduction of the fishing line, wherein the pivot device comprises a connecting rod which acts on the hook holder and which is movable along the retaining arm in a longitudinal direction, and wherein the retaining arm is hollow and the connecting rod is located in an interior of the retaining arm.

2. The device of claim 1, wherein the hook holder is exchangeable.

3. The device of claim 2, wherein the connecting rod engages with the hook holder in a detachable manner.

4. The device of claim 3, wherein a front end of the connecting rod is angled and engages with an opening at the hook holder extending in a transverse direction.

5. The device of claim 2, wherein the hook holder is connected to the retaining arm via a head portion which is for being fixed to the front end of the retaining arm, with the hook holder being pivotable with regard to the head portion.

6. The device of claim 5, wherein the head portion is for being inserted at the front end of the retaining arm and is for being secured by means of a snap-in mechanism.

7. The device of claim 6, wherein the snap-in mechanism comprises a spring band located in the interior of the retaining arm.

8. The device of claim 7, wherein a free end of the spring band comprises a projection which snaps, via an opening in a wall of the retaining arm, into an opening of the head portion.

9. The device of claim 7, wherein another end of the spring band is designed as a sleeve having an outer side abutting onto an inner side of a wall of the retaining arm.

10. The device of claim 1, wherein the head portion is angled for providing for a radial offset of the hook holder relative to the retaining arm.

11. The device of claim 1, wherein the hook holder is connected to the head portion via a hinge bolt located at a rear end of the hook holder.

12. The device of claim 1, wherein the pivot device comprises a slider member which is operable for movement in a longitudinal direction of the retaining arm in order to drive the connecting rod.

13. The device of claim 12, wherein the connecting rod engages with the slider member in a detachable manner.

14. The device of claim 13, wherein a rear end of the connecting rod is angled and is for being inserted into a receptacle in the slider member.

15. The device of claim 12, wherein a handle is located at the rear end of the retaining arm in such a manner that the handle and the retaining arm are located in a pistol-like manner relative to each other.

16. The device of claim 15, wherein the slider member comprises a finger trigger.

17. The device of claim 16, wherein the slider member is guided in a recess of the handle.

18. The device of claim 1, wherein a clamping device for the fishing line is provided at a rear end of the retaining arm.

19. The device of claim 18, wherein the clamping device comprises a convex disc which is pressed against a surface of a handle by means of an elastic element and a screw in an adjustable manner.

20. The device of claim 1, wherein the slot is spiral.

21. The device of claim 1, wherein the device is made of such materials that it floats in water.

22. The device of claim 1, wherein a front end of the hook holder is funnel-shaped.

23. The device of claim 1, wherein a front end of the hook holder is oblique.

24. The device of claim 23, wherein a shorter end of the oblique front end of the hook holder is located opposite to that side towards which the hook holder is pivoted starting from the engaged position.

25. The device of claim 24, wherein the slot starts at a longer end of the oblique front end of the hook holder.
